(19) United States
(12) Patent Application Publication
(10) Pub. No.: US 2024/0256910 A1
(43) Pub. Date: Aug. 1, 2024

(54) SYSTEMS AND METHODS FOR TRACTABLE SPACE OPTIMIZATION

(71) Applicant: Walmart Apollo, LLC, Bentonville, AR (US)

(72) Inventors: Drishya Giri, Sunnyvale, CA (US); Kenneth David Kuhn, Pasadena, CA (US); Aravind Chiruvelli, Frisco, TX (US)

(21) Appl. No.: 18/104,136

(22) Filed: Jan. 31, 2023

(51) Int. Cl. G06N 5/022; G06N 3/04

(52) U.S. Cl. CPC G06N 5/022; G06N 3/04

(57) ABSTRACT

Systems and methods of optimizing digitally-represented space is disclosed. A request to optimize a digitally-represented space is received. The request includes a data structure storing the digitally-represented space and at least one optimization parameter. A set of elements for insertion into the digitally-represented space is obtained. Each element in the set of elements includes at least one independent variable. A predicted function for the digitally-represented space is generated that represents a relationship between the at least one optimization parameter and the at least one independent variable. The predicted function is generated by a scaled neural multiplicative model (SNMM) prediction model. An optimal allocation of a subset of the set of elements in the digitally-represented space is generated that maximizes the at least one optimization parameter. The data structure storing the digitally-represented space is updated to include the optimal allocation of the subset of the set of elements.

### TECHNICAL FIELD

This application relates generally to deep neural network (DNN)-based optimization, and more particularly, to shape constrained DNN-based tractable optimization.

### BACKGROUND

In order to solve certain optimization problems, such as space optimization problems, current systems apply a predict-then-optimize framework utilizing linear models to ensure the problem and solution are tractable. Certain space planning problems present unique problems that cannot be efficiently solved through linear models due to the failure of linear models to allow certain features to influence an optimal solution.

In addition, the sparsity of historical data for certain space optimization problems limits the applicability and accuracy of linear models. Some spaces present challenges to performing or collecting experimental distributions or usable space data, for example, having a large number of items that can be inserted into the space with each item having a low density interaction with the space. Current linear models are not able to accurately reflect sparse data sets.

### SUMMARY

In various embodiments, a system is disclosed. The system includes a database and a processor communicatively coupled to the database. The processor is configured to read a set of instructions to receive a request to optimize a digitally-represented space. The request includes a data structure storing the digitally-represented space and at least one optimization parameter. The processor is further configured to obtain, from the database, a set of elements for insertion into the digitally-represented space. Each element in the set of elements includes at least one independent variable. The processor is further configured to generate a predicted function for the digitally-represented space. The predicted function represents a relationship between the at least one optimization parameter and the at least one independent variable. The predicted function is generated by a scaled neural multiplicative model (SNMM) prediction model. The processor is further configured to generate an optimal allocation of a subset of the set of elements in the digitally-represented space and update the data structure storing the digitally-represented space to include the optimal allocation of the subset of the set of elements. The optimal allocation maximizes the at least one optimization parameter. The updated data structure is stored in the database.

In various embodiments, a computer-implemented method is disclosed. The computer-implemented method includes steps of receiving a request to optimize a digitally-represented space that includes a data structure storing the digitally-represented space and at least one optimization parameter and obtaining, from a database, a set of elements for insertion into the digitally-represented space. Each element in the set of elements includes at least one independent variable. The computer-implemented method further includes steps of generating a predicted function for the digitally-represented space. The predicted function represents a relationship between the at least one optimization parameter and the at least one independent variable and the predicted function is generated by a scaled neural multiplicative model (SNMM) prediction model. The computer-implemented method further includes a step of generating an optimal allocation of a subset of the set of elements in the digitally-represented space. The optimal allocation maximizes the at least one optimization parameter. The computer-implemented method includes a further step of updating the data structure storing the digitally-represented space to include the optimal allocation of the subset of the set of elements. The updated data structure is stored in the database.

In various embodiments, a non-transitory computer-readable medium having instructions stored thereon is disclosed. The instructions, when executed by at least one processor, cause a device to perform operations including receiving a request to optimize a digitally-represented space that includes a data structure storing the digitally-represented space and at least one optimization parameter and obtaining, from a database, a set of elements for insertion into the digitally-represented space. Each element in the set of elements includes at least one independent variable. The device generates a predicted function for the digitally-represented space. The predicted function represents a relationship between the at least one optimization parameter and the at least one independent variable and the predicted function is generated by a scaled neural multiplicative model (SNMM) prediction model. The device further generates an optimal allocation of a subset of the set of elements in the digitally-represented space. The optimal allocation maximizes the at least one optimization parameter. The device updates the data structure storing the digitally-represented space to include the optimal allocation of the subset of the set of elements. The updated data structure is stored in the database.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments.

FIG. 2 illustrates a network environment configured to perform DNN-based tractable space optimization, in accordance with some embodiments.

FIG. 3 illustrates an artificial neural network, in accordance with some embodiments.

FIG. 4 illustrates a deep neural network, in accordance with some embodiments.

FIG. 5 is a flowchart illustrating a method of allocation a digitally-represented space using a scaled neural multiplicative model (SNMM)-based prediction model, in accordance with some embodiments.

FIG. 6 is a process flow illustrating various steps of the method of allocating the digitally-represented space using an SNMM-based optimization model, in accordance with some embodiments.

FIG. 7 is a flowchart illustrating a method of training a SNMM-based optimization model, in accordance with some embodiments.

FIG. 8 is a process flow illustrating various steps of the method of training a SNMM-based optimization model, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for space optimization utilizing SNMM-based prediction models. In various embodiments, a data representation of a space is received. The data representation can represent any suitable space, such as a digital space, a physical space, a mixed space, etc. Data elements representing items that can be inserted into the space, or portions of the space, are obtained for a storage mechanism, such as a database. A space optimization engine is configured to apply a predict-then-optimize process to determine optimize placement or arrangement of a subset of the data elements within the data representation of the space. A prediction step is performed by predicting a functional form of a parametric function related to one or more parameters to be optimized within the space. A trained SNMM-based prediction model can be applied to predict the parametric function. The predicted function is transformed, for example, into a convex optimization formulation, to identify the optimal space allocation for the data elements within the data representation of the space.

In some embodiments, systems, and methods for space optimization utilizing SNMM-based prediction models includes a trained prediction model configured to predict, e.g., generate an expected value of, a parametric function including one or more parameters to be optimized within the space. As one non-limiting example, in some embodiments, the data representation of the space represents a retail space that can contain one or more fixtures. An SNIVM-based model is configured to generate a parametric function for a variable representative of assignment of brands to a plurality of fixtures within the retail space. In other embodiments, the space can represent any suitable digital and/or physical space and the optimization variable can include any suitable variable related to the use of the corresponding space.

In some embodiments, methods and systems for optimization of retail space are disclosed. A data representation of a retail space is received and an optimized placement of brands within the retail space is determined by a space optimization engine. The optimized placement can be determined by predicting a function representative of a relationship between one or more independent variables and a dependent variable. For example, in some embodiments, a trained prediction model can generate a function representative of sales value within a retail space based on placement of brands, categories, and/or departments within one or more fixtures in the retail space. A trained prediction model can include any suitable prediction model, such as a trained SNMM-based model.

After predicting the function, the space optimization engine is configured to determine a maximized solution for the function that maximizes the dependent variable. For example, continuing the previous example, the space optimization engine can be configured to maximize sales value within a retail space based on brand, category, and/or department features of elements that can be inserted into the space. The maximized solution is provided is as an optimized output of the space configuration.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, a neural network which is trained (e.g., configured or adapted) to predict a parametric function, is disclosed. A neural network trained to predict a parametric function may be referred to as a trained prediction function and/or a trained prediction model. A trained prediction model can be configured to generate a predicted parametric function representative of one or more parameters of interest, i.e., parameters to be optimized during an optimization phase of the predict-then-optimize process. The trained prediction model can include a trained DNN-based prediction model configured to generate a single or multi-parameter predicted parametric function.

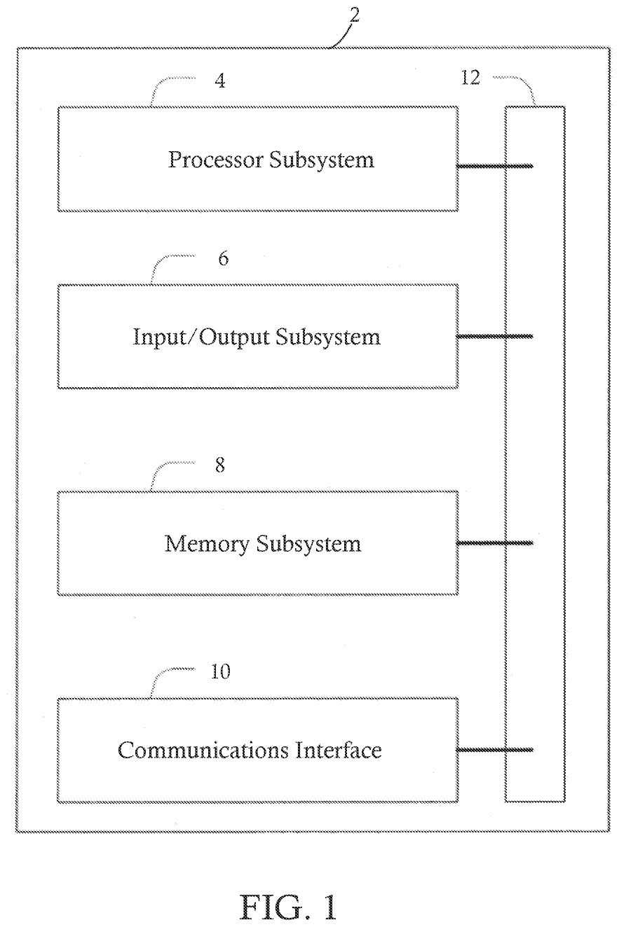

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electro-magnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for implementing a predict-then-optimize process including a DNN-based prediction model, as described herein. The instruction set can be stored in any acceptable form of machine-readable instructions, including source code or various appropriate programming languages. Some examples of programming languages that can be used to store the instruction set comprise, but are not limited to: Java, C, C++, C #, Python, Objective-C, Visual Basic, or .NET programming. In some embodiments a compiler or interpreter is comprised to convert the instruction set into machine executable code for execution by the processor subsystem 4.

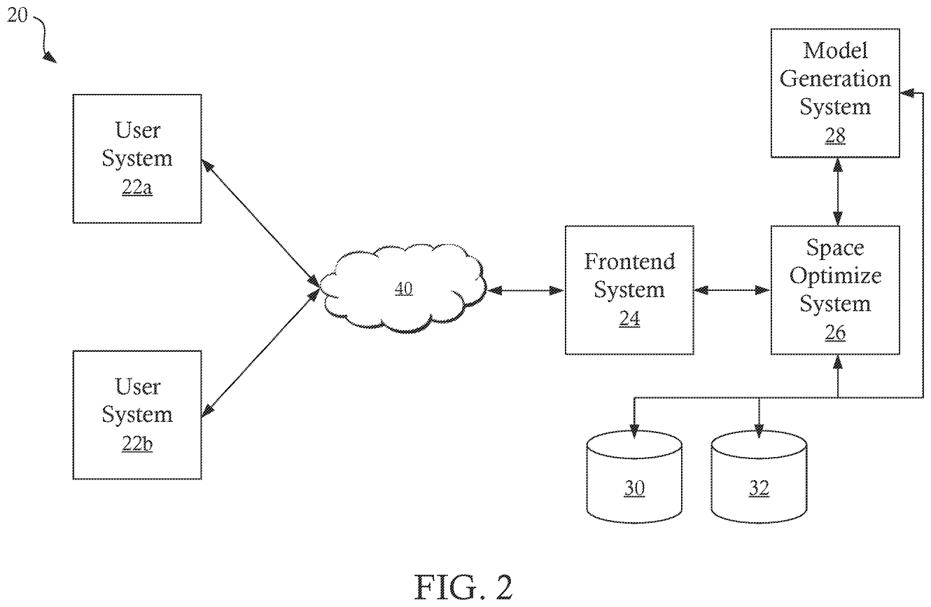

FIG. 2 illustrates a network environment 20 configured to provide optimization of digitally-represented spaces, in accordance with some embodiments. The network environment 20 includes a plurality of systems configured to communicate over one or more network channels, illustrated as network cloud 40. For example, in various embodiments, the network environment 20 can include, but is not limited to, one or more planning systems 22a, 22b, a frontend system 24, a space optimization system 26, a model training system 28, an item database 30, and a model database 32. Although embodiments are discussed herein including the illustrated network environment 20, it will be appreciated that the network environment 20 can include additional systems not illustrated, for example, additional instances of illustrated systems and/or additional networked systems. In addition, it will be appreciated that two or more the illustrated systems can be combined into a single system.

In some embodiments, the planning systems 22a, 22b are configured to provide a user interface to allow a user to implement planning processes for a digitally-represented space. The digitally-represented space can include any suitable space, such as a digital-only space, a physical-only space, and/or a mixed physical and digital space. In some embodiments, the planning systems 22a, 22b are configured to provide for space planning of retail spaces including a plurality of items selected from a catalog of available items that are displayed on various fixtures or other display elements. The digitally-represented space can include sub-spaces or partitions defining sections of the space configured to allow for positioning of elements having predetermined parameters, such as fixtures within a retail space, website portions within an interface, and/or other sub-portions of a digitally-represented space.

In some embodiments, the digitally-represented space includes a digital representation of a space having dimensional parameters, such as, for example, length, width, height, floorspace, square footage, pixel count, screen size, etc. In some embodiments, the digitally-represented space includes non-dimensional parameters, such as categories, themes, expected value, and/or any other suitable parameters related to the digitally-represented space. The digitally-represented space is capable of having one or more digital elements positioned therein, with each of the digital elements taking up a portion of one or more available parameters. For example, in embodiments including dimensional parameters, each of the one or more digital elements includes a data structure having dimensional parameters defining the amount of relevant dimensional parameters consumed by the digital element (e.g., a digital element can include a data structure having a length, width, height, floorspace, pixel count, etc.). In some embodiments, the digitally-represented space can be divided into sub-spaces.

In some embodiments, a planning system 22a, 22b is configured to provide planning of the digitally-represented space for a set of elements selected from a plurality of digital elements. For example, in some embodiments, the planning system 22a, 22b is configured to provide for planning of a digitally-represented retail space that includes display of various items on one or more fixtures. The planning system 22a, 22b can be configured to provide for allocation of a digitally-represented space to include one or more digitally-represented elements, such as, for example, fixtures configured to contain one or more products.

In some embodiments, a planning system 22a, 22b is in data communication with a frontend system 24. The frontend system 24 is configured to provide a network interface to the planning system 22a, 22b. The network interface can include any suitable network interface, such as, for example, a webpage, an intranet page, etc. The network interface is configured to allow a user to perform planning and/or optimization tasks related to planning for a digitally-represented space. In some embodiments, the frontend system 24 is configured to generate a planning interface providing access to one or more planning processes, such as a predict-then-optimize process discussed in greater detail herein.

In some embodiments, the frontend system 24 is in data communication with a space optimization system 26. The space optimization system 26 is configured to receive a request for optimization of a space from the frontend system 24, for example, in response to data provided from a planning system 22a, 22b to the frontend system 24. In some embodiments, the request for optimization can include one or more parameters of the space and/or one or more parameters of interest (e.g., parameters to be optimized by an optimization process). In some embodiments, the space optimization system 26 is configured to retrieve one or more parameters of a space from a database in response to the request for optimization of the space.

The space optimization system 26 is configured to implement a space optimization engine to optimize a digitally-represented space. In some embodiments, the space optimization engine is configured to implement a predict-then-optimize framework including a function prediction process and an optimization process. The function prediction process can include prediction (e.g., generation) of a function representative of a relationship between at least one dependent variable to be optimized and one or more independent input variables (e.g., parameters of interest). In some embodiments, a SNMM-based model is configured to predict a function for the selected set of parameters of interest.

It will be appreciated that the use of machine learning models, and in particular the use of a SNMM-based prediction model, allows for the prediction of functions that otherwise would not be possible without the use of the disclosed computer-implemented methods and systems. For example, a SNMM-based prediction model includes a model, generated by iterative training over hundreds or thousands of iterations, that can generate a predicted function for one or more identified parameters of interest within a usable timeframe. The processes necessary to predict a function cannot be performed, either literally or practically, by a human mind. Both the training process used to generate a SNMM-based prediction model and the implementation of the underlying structure of the SNMM-based prediction model are intrinsically tied to the computer hardware and software that implements those processes and provide an improvement to the operation of the underlying hardware and software when performing certain computer functions, such as space optimization and planning as disclosed herein.

In some embodiments, the space optimization engine implements an optimization process configured to optimize the function generated by the function prediction process. The optimization process is configured to convert the function to a tractable (e.g., solvable) convex formulation to allow for finding of an optimal space utilization of the digitally-represented space for the selected parameters of interest. As discussed in further detail below, in some embodiments, the optimization process is formulated as a two-step process configured to apply a power cone formulation to optimize a given digitally-represented space.

It will be appreciated that the application of the optimization process allows for the generation and solving of optimization equations in a timeframe that is not practically possible by a human mind, alone or in conjunction with computer-assisted tools. The processes necessary to generate a convex, tractable function and/or solve for optimization of a convex function, as presented herein, cannot be performed, either literally or practically, by a human mind within any reasonable time frame. The specifically disclosed computer-implemented processes allow for optimization solutions to be generated in a reasonable (e.g., polynomial) time frame that previously was not possible without the disclosed systems and methods.

In some embodiments, the space optimization system 26 is configured to obtain data elements representative of items that can potentially be inserted into a space from a database, such as the item database 30. For example, in some embodiments, the item database 30 is configured to store data representations of items, such as digital items (e.g., digital assets, banners, carousels, etc.) and/or physical items (e.g., products, fixtures, etc.) that can be positioned within the digital representation of the space. The data representations include data representative of relevant parameters of the items, such as, for example, dimensions, features, brand, categories, departments, and/or other parameters relevant to insertion of the item into the digitally-represented space.

In some embodiments, the optimized solution for placement of elements within the digitally-represented space can be displayed via a display, such as a display integrated with and/or in data communication with a planning system 22a, 22b. For example, in some embodiments, the space optimization system 26 is configured to generate an optimized distribution of a subset of elements within a digitally-represented space in response to a request from a planning system 22a, 22b. Data representative of the optimized space, such as, for example, a data structure configured to store a space identifier and data representative of the optimized distribution of elements within a space identified by the space identifier, can be provided to the frontend system 24. The data representative of the optimized space can be provided directly to the frontend system 24 and/or can be stored in a storage mechanism, such as a database, by the space optimization system 26 and subsequently retrieved by the frontend system 24. The frontend system 24 is configured to generate an interface for display, for example via a planning system 22a, 22b, that includes the data representative of the optimized space. The interface can include a digital floorplan, digital interface plan, statistics, vectors, and/or any other graphical representation of the space and the optimized distribution of elements within the space. The interface is provided to a planning system 22a, 22b for display. In some embodiments, the planning system 22a, 22b is configured to allow adjustments to the optimized space distribution.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

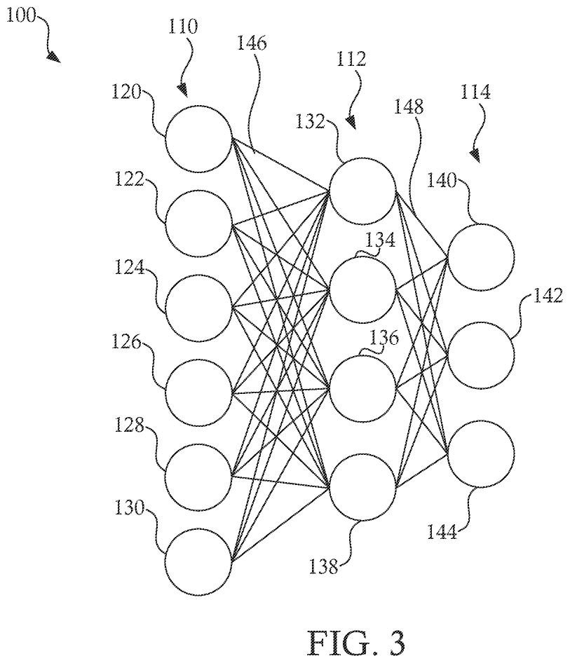

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 140-142, wherein each edge 140-142 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 140-142 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 140-142 between the nodes 120-144. In particular, edges 140-142 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, x⁽ⁿ⁾i denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 140-142 can comprise a weight being a real number, in particular, the weight is a real number within the interval [−1, 1] or within the interval [0, 1]. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${{w}^{′}}_{i , j}^{( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

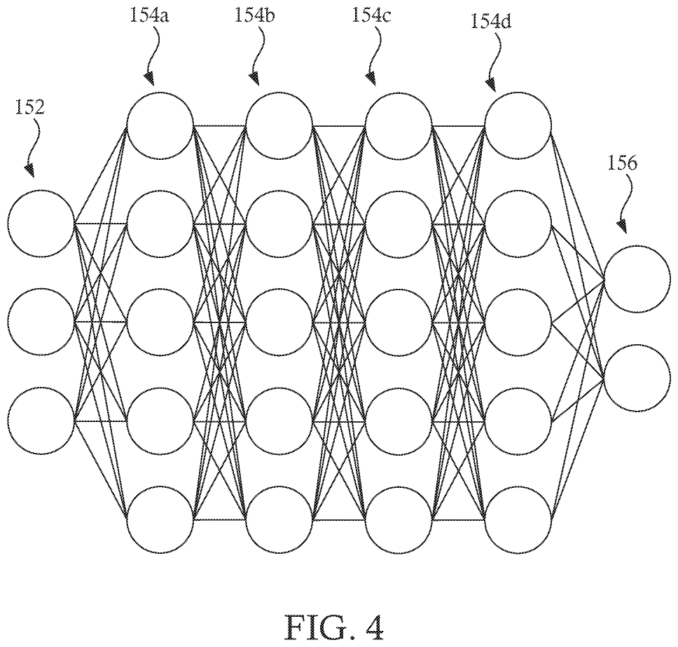

FIG. 4 illustrates a deep neural network (DNN) 150, in accordance with some embodiments. The DNN 150 is an artificial neural network, such as the neural network 100 illustrated in conjunction with FIG. 3, that includes representation learning. The DNN 150 can include an unbounded number of (e.g., two or more) intermediate layers 154a-154d each of a bounded size (e.g., having a predetermined number of nodes 156a-156), providing for practical application and optimized implementation of a universal classifier. Each of the layers 152a-152d can be heterogenous. The DNN 150 can is configured to model complex, non-linear relationships. Intermediate layers, such as intermediate layer 154c, can provide compositions of features from lower layers, such as layers 152a, 152b, providing for modeling of complex data.

In some embodiments, the DNN 150 can be considered a stacked neural network including multiple layers each configured to execute one or more computations. The computation for a network with L hidden layers can be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where α^{(l)} (x) is a preactivation function and h^{(l)}(x) is a hidden-layer activation function providing the output of each hidden layer. The preactivation function α^{(l)} (x) can include a linear operation with matrix W^{(l)} and bias b^{(l)}, where:

$${a}^{( l )} ( x ) = {W}^{( l )} x + {b}^{( l )}$$

In some embodiments, the DNN 150 is a feedforward network in which data flows from an input layer 152 to an output layer 156 without looping back through any layers. In some embodiments, the DNN 150 can include a backpropagation network in which the output of at least one hidden layer is provided, e.g., propagated, to a prior hidden layer. The DNN 150 can include any suitable neural network, such as a self-organizing neural network, a recurrent neural network, a convolutional neural network, a modular neural network, and/or any other suitable neural network.

In some embodiments, a DNN 150 can include a neural additive model (NAM). An NAM includes a linear combination of networks, each of which attends to (e.g., provides a calculation regarding) a single input feature. For example, an NAM can be represented as:

$$y = β + {f}_{1} ( {x}_{1} ) + {f}_{2} ( {x}_{2} ) + … + {f}_{K} ( {x}_{K} )$$

where β is a bias and each fᵢ is parametrized by a neural network. In some embodiments, the DNN 150 can include a neural multiplicative model (NMM), including a multiplicative form for the NAM mode using a log transformation of the dependent variable γ and the independent variable x:

$$y = {e}^{β} {e}^{f ( log x )} {e}^{\sum {{if}_{i}}^{d} ( {d}_{i} )}$$

where d represents one or more additional features of the input. In general, a neural network model does not provide a tractable solution for optimization (e.g., the equation cannot be optimized in polynomial time). In some embodiments, a NMM model can include a linear functional form of f that can be modeled via linear layers. A predetermined hidden dimension, such as, for example, a hidden dimension of 100, can be used to generate a predetermined set of linear layers, such as, for example, 2 linear layers:

$$y = {e}^{β} {x}^{{w}_{2}^{′} {w}_{1}} {e}^{{w}_{2}^{′} {b}_{1} + {b}_{2}} {e}^{{\sum {if}_{i}^{d} ( {d}_{i} )}_{}}$$

where w₁ and w₂ are weights for the first and second linear layers, respectively, and b₁ and b₂ are biases for the first and second linear layers, respectively. In some embodiments, the parameters of an NMM model can be constrained to produce a concave function for optimization, for example, by constraining 0≤w ₂w₁≤1.

In some embodiments, the DNN 150 is configured, or trained, to predict, or generate, a functional form F_{θ}, that captures a relationship between at least one dependent variable (e.g., an output) and one or more independent variables (e.g., input parameters). For example, in embodiments including optimization of a digitally-represented retail space, F_{θ} can be representative of a relationship between a dependent sales output and an independent fixture count input within the space and/or a portion of the space. Although specific embodiments are discussed herein, it will be appreciated that a trained DNN 150 can be configured to predict any suitable functional form F_{θ} representing the relationship between any suitable output and one or more inputs.

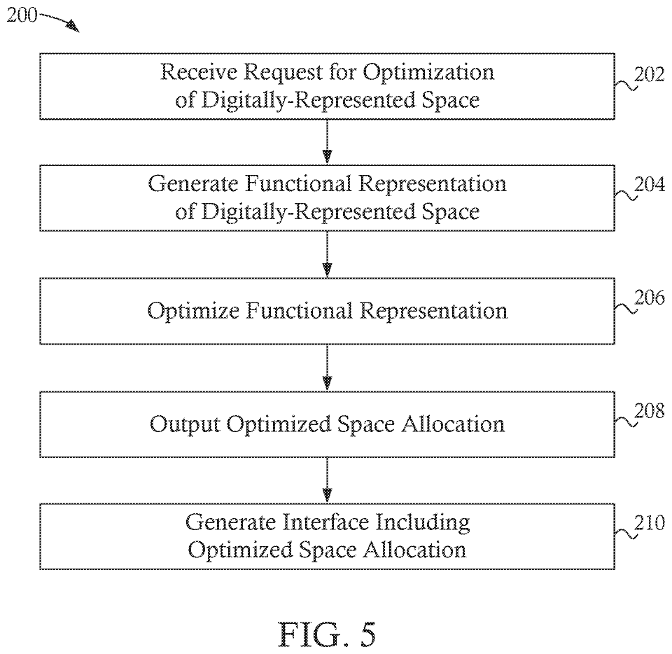

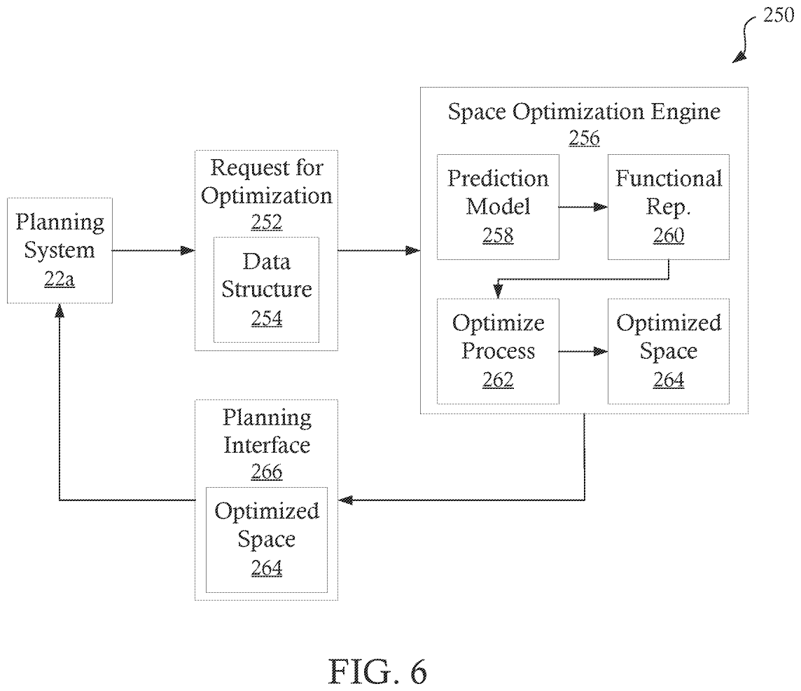

FIG. 5 is a flowchart illustrating a method 200 of optimizing a digitally-represented space for one or more parameters of interest, in accordance with some embodiments. FIG. 6 is a process flow 250 illustrating various steps of the method of optimizing a digitally-represented space for one or more parameters of interest, in accordance with some embodiments. At step 202, a request for optimization 252 of a space is received. In some embodiments, the request includes a space representation data structure 254. Alternatively, the request for optimization 252 can include data, such as a space identifier, referencing a space representation data structure 254 stored within a database or other storage structure. The digitally-represented space can include any suitable space and/or any portion of a space. For example, in some embodiments the digitally-represented space is representative of a physical space such as a retail environment and/or a portion of a retail environment, such as a portion of a retail store devoted to a predetermined category of items. As another example, in some embodiments, the digitally-represented space can include a digital space, such as a network interface and/or a portion of a network interface, such as a header, footer, sidebar, etc. The request can be received from any suitable system, such as a planning system 22a, 22b and/or a frontend system 24. Similarly, the request can be received by any suitable system and/or engine, such as, for example, a space optimization engine 256.

In some embodiments, the request for optimization 252 includes data identifying one or more parameters of interest, e.g., parameters to be optimized. For example, in embodiments including a digital-representation of a physical space, the request for optimization 252 can identify one or more parameters of the space, such as floorspace, as an input parameter and one or more parameters, such as expected sales, as a target output parameter, with placement within the floorspace being adjusted to optimize the expected sales target output parameter. As another example, in some embodiments including a digital-representation of a digital space, such as an interface, the request for optimization 252 can identify one or more parameters of the interface, such as zones or portions of the interface, as an input parameter and one or more parameters, such as engagement, as a target output parameter. Although specific embodiments are discussed herein, it will be appreciated that the disclosed method 200 can be used to optimize any digitally-represented space for insertion of any suitable elements into the space.

In some embodiments, the request for optimization 252 includes data identifying a category containing one or elements that can be inserted into the digitally-represented space. Each element includes one or more features associated therewith. For example, in embodiments including a digital representation of a physical space, the elements can include physical features, such as the amount of space (e.g., height, width, length, floorspace, square footage, etc.) that the element occupies, the number of predefined spaces within the physical space that is occupied by an element (e.g., fixture count), and/or any other suitable parameter, item features such as brand, department, category, features related to historical values of the items (e.g., historical sales), and/or any other suitable features. Similarly, in embodiments including a digital representation of a digital space, the elements can include parameters related to display of the digital space, such as the amount of screen space (e.g., pixels, containers, etc.) occupied by an element, interact data for the elements (e.g., views, add-to-cart, clicks, etc.), and/or any other suitable features. The elements within each category can include homogenous elements and/or can include diverse elements having varying features or feature values.

In some embodiments, each of the one or more elements are associated with historical data representative of interactions with the elements within a space, such as the digitally-represented space and/or a space analogous to the digitally-represented space. In some embodiments, each of the elements can include a fixture having a brand, category, and/or other identifying feature associated with historical interaction data for the given feature. The historical data can include, but is not limited to, historical sales data associated with the given brand, category, and/or other identifying feature of the element, historical interaction data, preference data, advertising data, and/or any other suitable data relevant to the optimization of the elements within the digitally-represented space.

At step 204, a functional representation 260 of the digitally-represented space is generated. For example, in some embodiments, a space optimization engine 256 is configured to implement a trained prediction model 258, such as a trained SNMM-based prediction model, to generate a function representation (F₀) 258 of the space. The functional representation 260 is a function (Fa) that maps one or more independent variables, e.g., input parameters or features, of each of the potential elements that can be inserted into the digitally-represented space to a dependent variable, e.g., output value, that is to be optimized. For example, in some embodiments including a digital-representation of a physical, retail space, the input variable of interest in the optimization is a fixture count that defines shelf space within the store and the output is total sales for the physical, retail space.

Given a closed set of [symbol] and a function F_{θ} (e.g., a function that is parameterized by θ) optimization of the space can be represented by:

$${x}^{*} = arg {max}_{x ∈ X} {F}_{θ} ( x )$$

The complexity of an underlying optimization model is based on a form of the function F₀, which may be referred to as an objective function, and the definition of the set of [symbol] , which may be referred to as the constraints on the function. Optimization of a space is generally tractable only for concave functions with respect to x. Although more general functional forms can be incorporated using, for example, mixed integer programming (MIP) with piecewise linear approximations, such solutions do not scale well for large problems and are not tractable, e.g., are not solvable within polynomial time.

In some embodiments, in order to provide for optimization of the space within polynomial (e.g., tractable or reasonable) time, the space optimization engine 256 is configured to implement a neural multiplicative model (NMM), and in particular a scaled NMM (SNMM) for demand learning to provide for a tractable formulation of the function F₀. A SNMM includes an NMM having a scaling of the feature x applied before the log transformation:

$$y = {e}^{β} {z}^{{σ ( {w}_{2} )}^{′} σ ( {w}_{1} )} {e}^{{σ ( {w}_{2} )}^{′} {b}_{1} + {b}_{2}} {e}^{{\sum }_{i} {f}_{i}^{d} ( {d}_{i} )}$$

$$z = 1 + max ( 0 , {s}_{2}^{′} {s}_{1} x + {s}_{2}^{′} {t}_{1} + {t}_{2} )$$

where z represents the scaling of feature x before a log transformation, and where:

$$σ ( x ) = {\{ \frac{exp {x}_{i}}{{\sum }_{i} exp {x}_{i}} \}}_{i = 1}^{n}$$

where s₁ and s₂ are weights of the two linear layers used to scale the feature x before the log transformation, t₁ and t₂ represent respective biases of the two linear layers, y is the dependent variable, and x is the independent variable. The SNMM equation is tractable with respect to a subsequent optimization, as discussed in greater detail below, when s′₂s₁x+s′₂t₁+t₂≥0.

As one non-limiting example, in some embodiments, an SNMM prediction model can be configured to optimize a space for an expected output γ in view of an independent variable x, where the space has one or more subdivisions k and the independent variable includes feature pairs (i,j). In such embodiments, the SNMM equation can be rewritten as:

$${y}_{i , j , k} = {a}_{i , j , k} {z}_{i , j , k}^{γ}$$

$${z}_{i , j , k} = {s}_{2}^{′} {s}_{1} {x}_{i , j , k} + {s}_{2}^{′} {t}_{1} + {t}_{2}$$

$${a}_{i , j , k} = {e}^{β} {e}^{{σ ( {w}_{2} )}^{′} {b}_{1} + {b}_{2}} {e}^{{f}_{i} ( {d}_{i} ) + {f}_{j} ( {d}_{j} ) + {f}_{k} ( {d}_{k} )}$$

where γ is a space elasticity variable. For example, in one non-limiting embodiment, a retail space can be optimized for expected sales (e.g., γ is representative of sales) in view of a fixture count (e.g., x is representative of fixture count) where i is an indicator for a particular category, j is an indicator for a particular brand, and k is an indicator for a particular department. In some embodiments, α_{i,j,k} is constant with respect to the optimization variables.

At step 206, the predicted function, F_{θ}, is optimized. For example, in some embodiments, the space optimization engine 256 applies an optimization process 262 to optimize the function for the parameters of interest. In some embodiments, the optimization process is formulated as a set of elements [symbol] to be inserted into a set of subdivisions [symbol] of the digitally-represented space. The set of elements [symbol] can include feature sets, such as feature pairs (i,j) and the set of subdivisions [symbol] includes a plurality of subdivisions k of the space.

In some embodiments, an independent parameter, e.g., a variable input parameter, can be represented as x_{i,j,k} for a variable having a set of features i, j, k. An upper bound, u_{i,j,k} and a lower bound, l_{i,j,k} can be defined for the independent variable, the total available space can be represented by sₖ, the available space within a given subdivision can be represented by sₖ, and a space elasticity can be represented by γ. An optimization can be defined having an index of (i,j) to indicate dependency of the coefficients of a_{i,j,k} on the feature encodings. The optimization process 262 is configured to maximize y_{i,j,k} such that:

$$max {\sum }_{k ∈ K} {\sum }_{i , j ∈ I} {y}_{i , j , k}$$

$$s . t .$$

$${y}_{i , j , k} = f ( {x}_{i , j , k} ) , ∀ i , j , k$$

$${\sum }_{i , j ∈ I} {x}_{i , j , k} \leq {s}_{k} , ∀ k ∈ K$$

$${\sum }_{k ∈ K} {\sum }_{i , j ∈ I} {x}_{i , j , k} \leq s$$

$${l}_{i , j , k} \leq {x}_{i , j , k} \leq {u}_{i , j , k} , ∀ i , j , k$$

$${x}_{i , j , k} \geq 0 , ∀ i , j , k$$

As a continuation of the non-limiting example discussed above in which a retail space is optimized for expected sales (e.g., γ is representative of sales) in view of a fixture count (e.g., x is representative of fixture count) and where i is an indicator for a particular category, j is an indicator for a particular brand, and k is an indicator for a particular department, [symbol] is a set of brand, category pairs (i,j), [symbol] is a set of departments within the digitally-represented space, x_{i,j,k} is a fixture count for category i for brand j and department k, a_{i,j,k} is a coefficient of the category i for brand j and department k, l_{i,j,k} is a lower bound for the fixture count at a brand-category-department level, u_{i,j,k} is an upper bound for the fixture count at a brand-category-department level, sₖ is a total fixture count space available for department k, s is a total fixture count across all departments in [symbol] , and γ is space elasticity of the retail space.

The optimization process 262 can be configured to apply any suitable optimization process to solve the foregoing optimization equation. For example, in some embodiments, a power cone formulation is applied to solve the optimization problem.

At step 208, an optimized space allocation 264, e.g., the distribution of elements x_{i,j,k} within the digitally-represented space that maximizes y_{i,j,k}, is generated and, at step 210, an interface 266 is generated including the optimized space allocation 264. For example, in some embodiments, a planning system 22a requests an optimized space distribution of a digitally-represented space in view of at least one dependent variable. The planning system 22a generates a request 252, which can be provided to the frontend system 24 and subsequently provided to the space optimization engine 256. The space optimization engine 256 generates an optimized space allocation 264 and transmits the optimized space allocation 264 to the frontend system 24. The frontend system 24 generates a user interface including a graphical representation of the optimized space allocation 264, which is provided to the planning system 22a for display by a display integrally formed with and/or coupled to the planning system 22a.

In various embodiments, the disclosed method 200 provides improvement in space planning and optimization over previously available space planning systems. For example, the disclosed method 200 is scalable to any space including insertion of any elements having associated features and provides reduced time for determination of an optimal space allocation. For example, in some embodiments including retail space allocation, the time needed for generating an optimized space allocation 264 can be measured in hours, as compared to current planning processes which produce non-optimal solutions and take multiple weeks to complete. The disclosed method 200 prioritizes and allocates space optimally to increase the target dependent variable, for example, increasing retail sales and reducing inventory in retail environments. The disclosed method 200 is further able to integrate elements not previously included within a space, for example, providing a cold-start optimization for new or previously non-included elements.

The disclosed method 200 provides a predict-then-optimize framework that is tractable in the predicted functional form. The disclosed method 200 is configured to consider space in terms of defined units, for example, defining a digitally-represented retail space in terms of fixture count and allocating space by the number of fixtures that can be allocated within the space. Although certain embodiments are disclosed herein with respect to retail spaces and fixture counts, it will be appreciated that the disclosed method 200 can be configured for any suitable digitally-represented space utilizing any defined unit of space and any defined optimization parameters.

Further, although embodiments are discussed herein including space optimization, it will be appreciated that the disclosed method 200 can be utilized for other optimizations, such as revenue optimization, advertisement optimization, etc., where the parameters of interest define the digitally-represented space in terms of the desired optimization (e.g., a revenue space, an advertisement space, etc.) and the space is optimized with respect to elements related to the defined space.

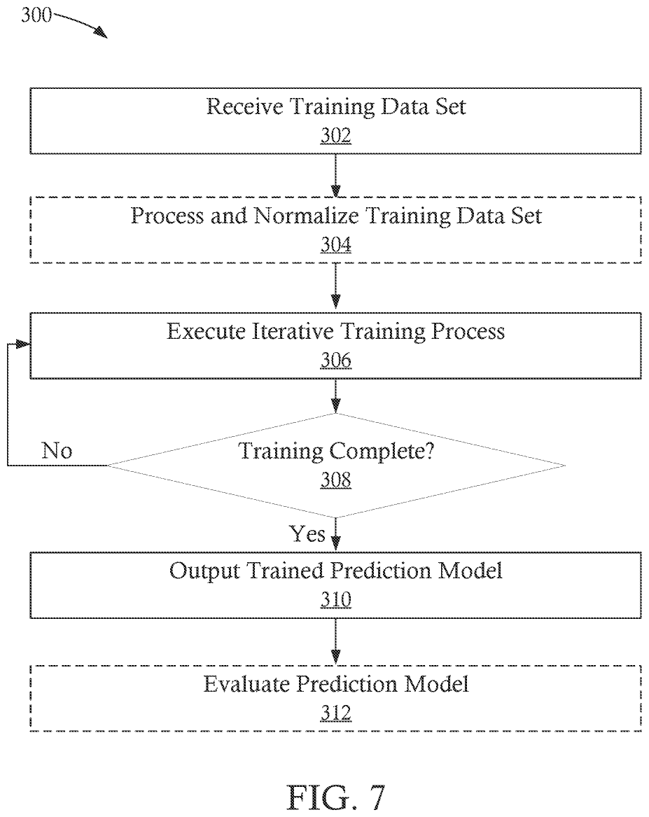

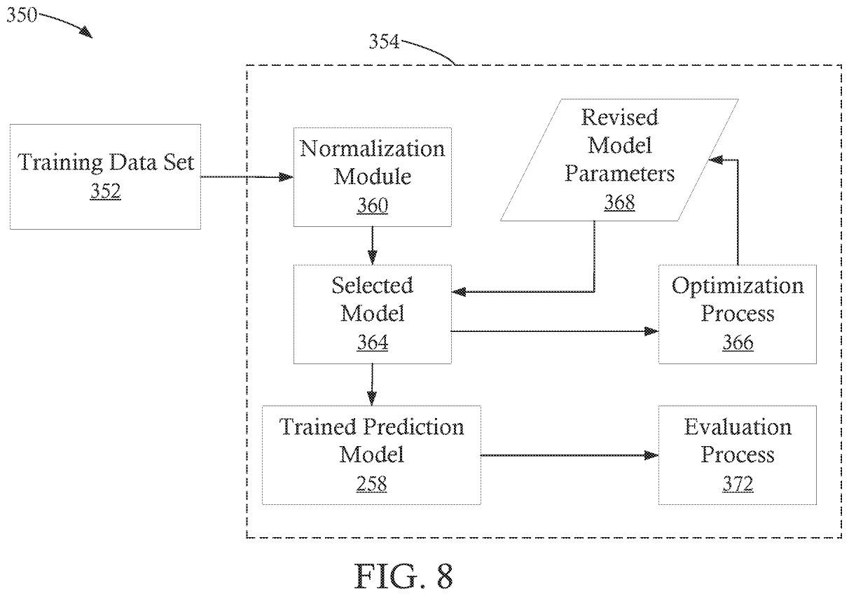

FIG. 7 is a flowchart illustrating a method 300 of generating a trained SNMM prediction model, in accordance with some embodiments. FIG. 8 is a process flow 350 illustrating various steps of the method of generating a trained SNMM prediction model, in accordance with some embodiments. A step 302, a training dataset 352 is received by model training engine 354. The training dataset 352 can include labeled, semi-labeled, and/or unlabeled data.

In some embodiments, the training dataset 352 can include data related to use of digitally-represented spaces, such as, for example, historical space allocation for digitally-represented spaces and various interaction data for the digitally-represented spaces, such as historical sales volume, historical traffic volume, historical interactions, etc. The training dataset 352 can further include element data related to elements positioned within the digitally-represented spaces and features related to the allocated elements. For example, in some embodiments, elements can include physical elements positioned within a physical space and/or digital elements positioned with a digital space.

At optional step 304, the received training dataset 352 is processed and/or normalized by a normalization module 360. For example, in some embodiments, the training dataset 352 can be augmented by imputing or estimating missing values of one or more features associated with certain elements. In some embodiments, processing of the received training dataset 352 includes outlier detection configured to remove data likely to skew training of a state prediction model. In some embodiments, processing of the received training dataset 352 includes removing features that have limited value with respect to training of the SNMM prediction model.

At step 306, an iterative training process is executed to train an untrained model 364. For example, a model training engine 454 can be configured to obtain an untrained model 364 including an untrained (e.g., base) machine learning framework, such as a DNN framework, and/or a partially or previously trained model (e.g., a prior version of a trained prediction model, a partially trained model from a prior iteration of a training process, etc.), from a model store, such as a model store database 32. The model training engine 354 is configured to iteratively adjust parameters (e.g., hyperparameters) of the intermediate layers of the untrained model 464 to generate a trained SNMM prediction model. In some embodiments, hyperparameter adjustment is performed per layer and/or for multiple layers simultaneously and can be based on one or more cost functions.

In some embodiments, the model training engine 354 implements an iterative training process that generates a set of revised model parameters 368 during each iteration. The set of revised model parameters 368 can be generated by applying an optimization process 366 to the cost function of the untrained model 364 and/or a cost function of an underlying hidden layer of the model. The optimization process 366 can be configured to reduce the cost value (e.g., reduce the output of the cost function) at each step by adjusting one or more parameters during each iteration of the training process.

After each iteration of the training process, at step 308, the model training engine 354 determines whether the training process is complete. The determination at step 308 can be based on any suitable parameters. For example, in some embodiments, a training process can complete after a predetermined number of iterations. As another example, in some embodiments, a training process can complete when it is determined that the cost function of the untrained model 364 has reached a minimum, such as a local minimum and/or a global minimum.

At step 310, a trained prediction model 258 is output and provided for use in a space optimization method, such as the method 200 discussed above with respect to FIGS. 5-6. At optional step 312, a trained prediction model 258 can be evaluated by an evaluation process 372 to determine the efficacy of the model. The trained prediction model 258 can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained prediction model 258.

In some embodiments, the disclosed SNMM model, and methods of generating trained SNMM models, can be adapted for prediction of any suitable function. For example, in various embodiments, an SNMM model can be trained to predict item-specific sales (e.g., car sales, puzzle sales), review values, digital spaces, physical spaces, mixed spaces, etc. It will be appreciated that an SNMM model can be adapted based on the training data provided during the iterative training process discussed above.

The disclosed methods improve the operation of the underlying systems, such as computer systems described in conjunction in FIG. 1, when performing operations related to generating digital space allocations (e.g., planning layouts, planograms, etc.) and generating interfaces or displays including digital space allocations. In particular, the disclosed methods provide for improvements in the optimization of digitally-represented spaces by providing for faster optimization and higher accuracy through deployed SNMM prediction models and reduced training time for an SNMM model as compared to traditional models, providing a reduction in required computing resources, including storage, processing power, processing time, etc.

The disclosed systems and methods provide for space optimization solutions not possible using traditional optimization processes. For example, existing processes for retail space optimization utilize shelf-space allocation methods that consider the length of shelf space available as compared to the length of shelf space occupied by a product. Shelf-space solutions are constrained to “facings,” or display of products in organized rows (or shelves). Optimization of retail space for non-shelf products, such as optimization of space for apparel products, which do not utilize traditional shelf-space distribution, cannot be solved by existing shelf-space solutions. The disclosed systems and methods are configured to optimize a space for placement of space elements, such as fixtures, which can include any arrangement within a digitally-represented space. Thus, the disclosed systems and methods can be used for solving space optimization problems, such as apparel display optimization, that cannot currently be solved (or cannot be solved in a reasonable time) using prior systems and methods.

Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database;
a processor communicatively coupled to the database, wherein the processor is configured to read a set of instructions to:
receive a request to optimize a digitally-represented space, wherein the request includes a data structure storing the digitally-represented space and at least one optimization parameter;
obtain, from the database, a set of elements for insertion into the digitally-represented space, wherein each element in the set of elements includes at least one independent variable;
generate a predicted function for the digitally-represented space, wherein the predicted function represents a relationship between the at least one optimization parameter and the at least one independent variable, and wherein the predicted function is generated by a scaled neural multiplicative model (SNMM) prediction model;
generate an optimal allocation of a subset of the set of elements in the digitally-represented space, wherein the optimal allocation maximizes the at least one optimization parameter; and
update the data structure storing the digitally-represented space to include the optimal allocation of the subset of the set of elements, wherein the updated data structure is stored in the database.

2. The system of claim 1, wherein the SNMM prediction model includes at least two linear layers each having a scaling weight and a bias.

3. The system of claim 2, wherein the SNMM prediction model generates the prediction function according to one or more subdivisions of the digitally-represented space.

4. The system of claim 3, wherein the optimal allocation is generated by an optimization process including an index of feature pairs.

5. The system of claim 3, wherein the digitally-represented space is representative of a retail space, and wherein the optimization parameter includes expected sales, the at least one independent parameter includes a fixture count, and wherein the SNMM model is configured to determine space optimization of a particular category within the retail space for a particular brand within a particular department.

6. The system of claim 3, wherein the optimal allocation is defined by the at least one independent variable, wherein the independent variable includes a set of features, and wherein the optimal allocation is constrained by an upper bound and a lower bound of the at least one independent variable.

7. The system of claim 1, wherein the optimal allocation of the subset of the set of elements is generated by applying a power cone formulation.

8. The system of claim 1, wherein the processor reads the set of instructions to generate an interface including the updated data structure storing the digitally-represented space and the optimal allocation of the subset of the set of elements.

9. A computer-implemented method, comprising
receiving a request to optimize a digitally-represented space, wherein the request includes a data structure storing the digitally-represented space and at least one optimization parameter;
obtaining, from a database, a set of elements for insertion into the digitally-represented space, wherein each element in the set of elements includes at least one independent variable;
generating a predicted function for the digitally-represented space, wherein the predicted function represents a relationship between the at least one optimization parameter and the at least one independent variable, and wherein the predicted function is generated by a scaled neural multiplicative model (SNMM) prediction model;
generating an optimal allocation of a subset of the set of elements in the digitally-represented space, wherein the optimal allocation maximizes the at least one optimization parameter; and
updating the data structure storing the digitally-represented space to include the optimal allocation of the subset of the set of elements, wherein the updated data structure is stored in the database.

10. The computer-implemented method of claim 9, wherein the SNMM prediction model includes at least two linear layers each having a scaling weight and a bias.

11. The computer-implemented method of claim 10, wherein the SNMM prediction model generates the prediction function according to one or more subdivisions of the digitally-represented space.

12. The computer-implemented method of claim 10, wherein the optimal allocation is generated by an optimization process including an index of feature pairs.

13. The computer-implemented method of claim 10, wherein the digitally-represented space is representative of a retail space, and wherein the optimization parameter includes expected sales, the at least one independent parameter includes a fixture count, and wherein the SNMM model is configured to determine space optimization of a particular category within the retail space for a particular brand within a particular department.

14. The computer-implemented method of claim 10, wherein the optimal allocation is defined by the at least one independent variable, wherein the independent variable includes a set of features, and wherein the optimal allocation is constrained by an upper bound and a lower bound of the at least one independent variable.

15. The computer-implemented method of claim 9, wherein the optimal allocation of the subset of the set of elements is generated by applying a power cone formulation.

16. The computer-implemented method of claim 9, comprising generating an interface including the updated data structure storing the digitally-represented space and the optimal allocation of the subset of the set of elements.

17. A non-transitory computer-readable medium having instructions stored thereon, wherein the instructions, when executed by at least one processor, cause a device to perform operations comprising:
receiving a request to optimize a digitally-represented space, wherein the request includes a data structure storing the digitally-represented space and at least one optimization parameter;
obtaining, from a database, a set of elements for insertion into the digitally-represented space, wherein each element in the set of elements includes at least one independent variable;
generating a predicted function for the digitally-represented space, wherein the predicted function represents a relationship between the at least one optimization parameter and the at least one independent variable, and wherein the predicted function is generated by a scaled neural multiplicative model (SNMM) prediction model;
generating an optimal allocation of a subset of the set of elements in the digitally-represented space, wherein the optimal allocation maximizes the at least one optimization parameter; and
updating the data structure storing the digitally-represented space to include the optimal allocation of the subset of the set of elements, wherein the updated data structure is stored in the database.

18. The non-transitory computer readable medium of claim 17, wherein the optimal allocation is defined by the at least one independent variable, wherein the independent variable includes a set of features, and wherein the optimal allocation is constrained by an upper bound and a lower bound of the at least one independent variable.

19. The non-transitory computer readable medium of claim 18, wherein the SNMM prediction model includes at least two linear layers each having a scaling weight and a bias, and wherein the SNMM prediction model generates the prediction function according to one or more subdivisions of the digitally-represented space.

20. The non-transitory computer readable medium of claim 18, wherein the digitally-represented space is representative of a retail space, and wherein the optimization parameter includes expected sales, the at least one independent parameter includes a fixture count, and wherein the SNMM model is configured to determine space optimization of a particular category within the retail space for a particular brand within a particular department.
